(19) United States
(12) Patent Application Publication
(10) Pub. No.: US 2025/0270454 A1
(43) Pub. Date: Aug. 28, 2025

(54) CATALYSTS FOR HYDROCRACKING OF FISCHER-TROPSCH WAX

(71) Applicant: EXXONMOBIL TECHNOLOGY AND ENGINEERING COMPANY, Spring, TX (US)

(72) Inventors: Matthew T. KAPELEWSKI, Lambertville, NJ (US); Raymond G. BURNS, III, Louisville, KY (US); Lei ZHANG, Basking Ridge, NJ (US)

(21) Appl. No.: 19/206,785

(22) Filed: May 13, 2025

Related U.S. Application Data
(63) Continuation of application No. PCT/US2023/079479, filed on Nov. 13, 2023.
(60) Provisional application No. 63/383,601, filed on Nov. 14, 2022.

(51) Int. Cl. C10G 47/14; B01J 29/12; B01J 29/74; B01J 35/30; B01J 35/31; B01J 35/61; B01J 35/63; B01J 37/02; B01J 37/08

(52) U.S. Cl. CPC C10G 47/14; B01J 29/126; B01J 29/74; B01J 29/7415; B01J 35/31; B01J 35/394; B01J 35/615; B01J 35/617; B01J 35/635; B01J 37/0201; B01J 37/0236; B01J 37/08

(57) ABSTRACT

Catalysts and corresponding methods are provided for conversion of Fischer-Tropsch wax to distillate boiling range products. The catalysts can correspond to noble metal catalysts supported on a support that includes a 3-dimensional zeotype and a substantially non-acidic or low acidity oxide binder. It has been discovered that using a substantially non-acidic or low acidity binder allows for improved yield of distillate boiling range products when cracking Fischer-Tropsch wax. It has further been discovered that by using a support including a 3-dimensional zeotype, the temperature for achieving a target level of conversion during hydrocracking can be reduced or minimized

### CROSS-REFERENCE TO RELATED APPLICATIONS AND PRIORITY CLAIM

This application is a Continuation of PCT/US2023/079479, filed Nov. 13, 2023, and titled “CATALYSTS FOR HYDROCRACKING OF FISCHER-TROPSCH WAX”, which claims the benefit of priority to U.S. Provisional Patent Application No. 63/383,601 filed Nov. 14, 2022, and titled “CATALYSTS FOR HYDROCRACKING OF FISCHER-TROPSCH WAX”, both of which are incorporated herein by reference in their entirety.

### FIELD OF THE INVENTION

Catalysts are provided, along with corresponding systems and methods, for using hydrocracking to improve the yield of liquid products from Fischer-Tropsch synthesis.

### BACKGROUND OF THE INVENTION

One pathway for production of liquid fuels from bio-derived sources is to convert biomass into a synthesis gas and then use Fischer-Tropsch (FT) synthesis to form fuel boiling range products. This type of pathway is advantageous because it avoids the need to directly form molecules of a target type and/or in a target boiling range. Instead, any convenient type of biomass can be broken down to form synthesis gas, and then FT synthesis is used to generate hydrocarbons.

Although Fischer-Tropsch synthesis conditions can be tuned to modify the average chain length, the output from FT synthesis typically corresponds to a product with a distribution of chain lengths according to the Anderson-Schulz-Flory distribution. Due to the nature of the distribution of chain lengths, using FT synthesis to form fuels boiling range also results in formation of a substantial amount of Fischer-Tropsch wax. Even under optimal conditions for producing distillate boiling range products, a Fischer-Tropsch synthesis process can typically produce 20 wt % or more of C₂₂₊ compounds that include a high proportion of paraffins. Such a C₂₂₊ fraction is an example of an FT wax. FT wax produced from syngas conversion is typically a highly paraffinic and high melting wax that is free of sulfur and nitrogen impurities. To increase the yield of fuels boiling range compounds (such as distillate boiling range compounds or naphtha boiling range compounds), the wax produced in this process must be further processed. Typical processing includes hydrocracking to form lighter molecules, with a range targeted based on the hydrocracking catalyst being used. It would be desirable to have improved catalysts, systems, and/or methods for converting such FT wax into fuels boiling range compounds.

U.S. Pat. No. 7,704,378 describes a catalyst for hydrocracking of a heavy Fischer-Tropsch fraction. The catalyst includes a silica-alumina support where the distribution of silica and alumina in the support is not uniform. Instead, there are distinct regions within the support having different ratios of silica to alumina.

U.S. Pat. No. 8,679,323 describes hydrocracking of a heavy Fischer-Tropsch fraction. The catalyst includes base-modified dealuminated USY with a Si/Al ratio prior to base modification and prior to mixing with a binder or support of 2.5 to 20.

U.S. Pat. No. 8,142,644 describes hydrocracking and hydroisomerization of a Fischer-Tropsch fraction where 50 wt % or more of the fraction boils at 370° C. or higher. The catalyst includes a carrier with a pore volume of 0.8 ml/g or more and a median pore diameter of 85 Angstroms or more. Additionally, the pores have a high degree of cylindrical character.

U.S. Pat. No. 8,685,231 describes hydrocracking and hydroisomerization of a Fischer-Tropsch fraction where 50 wt % or more of the fraction boils at 370° C. or higher. The catalyst includes 15 wt % or less of zeolite Beta and 40 wt % or more of a silica-alumina binder or carrier.

U.S. Pat. No. 6,583,186 describes a method for processing Fischer-Tropsch feed. The Fischer-Tropsch feed is separated into a lighter fraction and a heavier fraction. The heavier fraction is then hydrocracked and optionally isomerized. The lighter fraction is then mixed with the resulting hydrocracked effluent.

U.S. Pat. No. 10,227,537 describes processing of Fischer-Tropsch wax in a multi-step process that includes hydrocracking in the presence of a hydrocracking catalyst containing a zeolite and amorphous silicon-alumina.

U.S. Patent Application Publication 2011/0049011 describes hydrocracking of Fischer-Tropsch wax fractions. The hydrocracking catalysts correspond to mixtures of zeolites with silica-alumina, alumina-boria, or silica-zirconia.

U.S. Patent Application Publication 2004/0256287 describes hydrocracking of waxy feeds using a catalyst containing an acidic matrix such as amorphous silica alumina. Optionally, the catalyst can further include up to 2 wt % of a zeolite, such as USY.

### SUMMARY

In an aspect, a method is provided for hydrocracking a waxy feedstock. The method includes exposing a feedstock comprising 70 wt % or more of paraffins and having a T10 distillation point of 280° C. or higher to a catalyst under hydrocracking conditions corresponding to 20 wt % or more conversion relative to 371° C. to form a hydrocracking effluent. The catalyst can include 0.1 wt % to 3.0 wt % of a Group 8-10 noble metal on a support including a 3-dimensional 12-member ring zeotype framework and a metal oxide binder. The support can have an Alpha value of 15 or less.

### BRIEF DESCRIPTION OF THE DRAWINGS

FIG. 1 shows distillate yield versus feed conversion relative to 371° C. for hydrocracking of a waxy feed in the presence of various hydrocracking catalysts.

FIG. 2 shows the reaction temperature for achieving 50 wt % conversion relative to 371° C. for hydrocracking of the waxy feed in the presence of various hydrocracking catalysts.

FIG. 3 shows distillate yield and naphtha yield versus temperature during hydrocracking of the waxy feed in the presence of various hydrocracking catalysts.

### DETAILED DESCRIPTION

### Overview

In various aspects, catalysts and corresponding methods are provided for conversion of Fischer-Tropsch wax to distillate boiling range products. The catalysts can correspond to noble metal catalysts supported on a support that includes a 3-dimensional zeotype and a substantially non-acidic or low acidity oxide binder. It has been discovered that using a substantially non-acidic or low acidity oxide binder allows for improved yield of distillate boiling range products when cracking Fischer-Tropsch wax. It has further been discovered that by using a support including a 3-dimensional zeotype, the temperature for achieving a target level of conversion during hydrocracking can be reduced or minimized.

Conventionally, methods for improving the yield of distillate fuels from Fischer-Tropsch synthesis have focused on using catalysts corresponding to Group 8-10 metals supported on acidic support materials to crack the higher boiling range/waxy portion of the Fischer-Tropsch synthesis product. Conventionally, this acidity is believed to improve the cracking capabilities of the catalytic material. This acidic functionality in the support typically includes at least an acidic matrix material or binder. Examples of such acidic, amorphous matrix materials or binders include silica-alumina and fluorinated alumina. Acidity is often also provided based on the use of a zeotype framework in the support material.

In contrast to conventional methods, it has been discovered that high yields of distillate boiling range products can be achieved by cracking Fischer-Tropsch wax using catalysts based on using Group 8-10 noble metals (e.g., Pt, Pd) on low acidity support materials that include three-dimensional zeotype frameworks. The 3-dimensional zeotypes can include, for example, USY, zeolite Beta, and MCM-68. By including a three-dimensional zeotype framework in the low acidity support, sufficient cracking activity is provided to achieve high yields of distillate compounds during cracking of Fischer-Tropsch wax while operating at low enough temperatures to reduce or minimize thermal cracking reactions over the course of a commercial scale processing run. Additionally, it was unexpectedly found that the yield of distillate during hydrocracking with the noble metal, low acidity catalyst including a zeotype framework structure was higher than the corresponding yield of distillate when using an amorphous catalyst for the hydrocracking.

### Definitions

In this discussion, a zeotype is defined to refer to a crystalline material having a porous framework structure built from tetrahedra atoms connected by bridging oxygen atoms. Examples of known zeotype frameworks are given in the “Atlas of Zeolite Frameworks” published on behalf of the Structure Commission of the International Zeolite Association”, 6^{th} revised edition, Ch. Baerlocher, L. B. McCusker, D. H. Olson, eds., Elsevier, New York (2007) and the corresponding web site, http://www.iza-structure.org/databases/. Under this definition, a zeolite refers specifically to an aluminosilicate having a zeotype framework structure. Under this definition, a zeotype can refer to aluminosilicates (i.e., zeolites) having a zeotype framework structure as well as crystalline structures containing oxides of heteroatoms different from silicon and aluminum. Such heteroatoms can include any heteroatom generally known to be suitable for inclusion in a zeotype framework, such as gallium, boron, germanium, phosphorus, zinc, and/or other transition metals that can substitute for silicon and/or aluminum in a zeotype framework. It is noted that under this definition, a zeotype can include materials such as silicoaluminophosphate (SAPO) materials or aluminophosphate (AlPO) materials.

The Alpha value is a measure of the cracking activity of a catalyst and is described in U.S. Pat. No. 3,354,078 and in the Journal of Catalysis, Vol. 4, p. 527 (1965); Vol. 6, p. 278 (1966) and Vol. 61, p. 395 (1980), each incorporated herein by reference. It is based on the activity of the active silica-alumina cracking catalyst taken as an Alpha of 1 (Rate Constant=0.016 sec⁻¹). The experimental conditions of the test used herein included a constant temperature of 538° C. and a variable flow rate as described in detail in the Journal of Catalysis, Vol. 61, p. 395 (1980).

In this discussion, conversion of a feedstock relative to 700° F. (371° C.) is defined based on the net weight percentage of the feedstock that boils at or above 371° C. prior to a process that is converted to compounds that boil below 371° C. after the conversion process. Unless otherwise specified, conversion values described herein correspond to single-pass conversion values.

In this discussion, “Tx” refers to the temperature at which a weight fraction “x” of a sample can be boiled or distilled. For example, if 40 wt % of a sample has a boiling point of 350° F. (177° C.) or less, the sample can be described as having a T40 distillation point of 350° F. (177° C.).

In this discussion, the distillate boiling range is defined as 160° C. (320° F.) to 371° C. A fraction that has a T10 distillation point of 160° C. or more and a T90 distillation point of 371° C. or less is defined as a distillate boiling range fraction. The naphtha boiling range is defined as the boiling point of a C₅ paraffin (roughly 29° C.) to 160° C. A fraction having a T10 boiling point of 29° C. or more and a T90 distillation point of 160° C. or less is defined as a naphtha boiling range fraction. It is noted that the T10 distillation point of a fraction must be equal to or less than the T90 distillation point, and that similarly the T90 distillation point of a fraction must be equal to or greater than the T10 distillation point. The distillation profile of a fraction, feed, or product is determined according to ASTM D2887. For a sample where ASTM D2887 is not appropriate for some reason, D86 (for lower boiling fractions) or D7169 (higher boiling fractions) may be used instead.

The “cloud point” of a sample is the temperature below which paraffin wax or other solid substances begin to crystallize or separate from the solution, imparting a cloudy appearance to the oil when the oil is chilled under prescribed conditions. Cloud point can be determined according to ASTM D2500.

Unless otherwise specified, the “Liquid Hourly Space Velocity (LHSV)” for a feed or portion of a feed to a reactor is defined as the volume of feed per hour relative to the volume of catalyst in the reactor. In some specific instances, a liquid hourly space velocity may be specified relative to a specific catalyst within a reactor that contains multiple catalyst beds.

In this discussion, a “Cx” hydrocarbon refers to a hydrocarbon compound that includes “x” number of carbons in the compound. A stream containing “Cx-Cy” hydrocarbons refers to a stream composed of one or more hydrocarbon compounds that includes at least “x” carbons and no more than “y” carbons in the compound. It is noted that a stream containing “Cx-Cy” hydrocarbons may also include other types of hydrocarbons, unless otherwise specified.

In this discussion, references to a “gas portion” or a “liquid portion” of a reaction effluent refer to the phase the effluent portion would be in at 20° C. and 100 kPa-a. In this discussion, references to a “gas phase portion” or a “liquid phase portion” of a reaction effluent refer to the phase the effluent portion is in at the specified conditions. For example, a “gas phase portion” of a hydrocracking effluent as the effluent exits from the reactor would refer to the portion of the hydrocracking effluent that is in the gas phase under the conditions present at the exit from the hydrocracking reactor. This could include compounds that boil at up to 400° C. or more, depending on the temperature at the exit from the hydrocracking reactor. By contrast, the “gas portion” of such a hydrocracking effluent would only correspond to the components of the effluent that are gas phase at 20° C. and 100 kPa-a, such as C₄ hydrocarbons, carbon oxides, hydrogen, H₂S, and other low boiling compounds.

In this discussion, references to a periodic table are defined as references to the current version of the IUPAC Periodic Table.

### Fischer-Tropsch Wax and Other Waxy Feedstocks

In various aspects, a noble metal catalyst on a low acidity support including a 3-dimensional zeolite can be used for hydrocracking of a waxy feedstock, such as wax produced by Fischer-Tropsch synthesis. Fischer-Tropsch synthesis is generally performed by exposing synthesis gas to an appropriate catalyst under Fischer-Tropsch synthesis conditions. Fischer-Tropsch synthesis reactions generally produce products containing a large proportion of paraffins (alkanes). Paraffins containing more than roughly 20 carbons typically correspond to compounds with boiling points above 371° C. Generally, a waxy feedstock corresponds to a feedstock with a T10 distillation point of 280° C. or higher, or 300° C. or higher, or 315° C. or higher, or 343° C. or higher, or 371° C. or higher. The T90 distillation point of a waxy feedstock and/or the final boiling point can be any convenient value, so long as the waxy feedstock has a sufficiently low viscosity to be able to be transported into the hydrocracking reactor using conventional methods. In some aspects, a waxy feedstock can have a T90 distillation point of 500° C. or more. In some aspects, a waxy feedstock can have a T90 distillation point of 650° C. or less. Such a waxy feedstock can be formed in any convenient manner. For example, after performing Fischer-Tropsch synthesis, the resulting liquid products can be separated to form one or more lower boiling fractions (such as a naphtha fraction and/or a distillate fraction and/or a light ends or gas fraction) and at least one higher boiling fraction with a T10 distillation point of 315° C. or higher, or 343° C. or higher, or 371° C. or higher.

A waxy feedstock can have a relatively high content of paraffins, as determined according to D5442. In some aspects, a waxy feedstock can have a total paraffin content of 70 wt % or more, relative to a weight of the waxy feedstock, or 80 wt % or more, or 90 wt % or more, such as up to substantially all of the waxy feedstock corresponding to paraffins. In some aspects, a waxy feedstock can have an n-paraffin content of 70 wt % or more, relative to a weight of the waxy feedstock, or 80 wt % or more, or 90 wt % or more, such as up to substantially all of the waxy feedstock corresponding to n-paraffins. It is noted that a waxy feedstock produced by Fischer-Tropsch synthesis (and/or other waxy feedstocks) may have an oxygenate content of 5.0 wt % or less, or 2.5 wt % or less, or 1.0 wt % or less, such as down to 0.1 wt %, or possibly down to having substantially no content of oxygenates. If desired, such oxygenates can be removed from a waxy feedstock by any convenient method prior to hydrocracking, such as by performing an initial hydrotreatment process on the waxy feedstock.

In some aspects, such as aspects where a substantial portion of the waxy feedstock is based on Fischer-Tropsch material, the waxy feedstock can have a relatively low content of sulfur and/or nitrogen. In such aspects, the sulfur content of the waxy feed can be 100 wppm or less, or 15 wppm or less, such as down to having substantially no sulfur content (0.1 wppm or less). Additionally or alternately, the nitrogen content of the waxy feed can be 50 wppm or less, or 15 wppm or less, such as down to having substantially no nitrogen content (0.1 wppm or less). Further additionally or alternately, the waxy feedstock can have a relatively low content of aromatics. In some aspects, the aromatics content of the waxy feed can be 10 wt % or less, or 2.5 wt % or less, such as down to having substantially no aromatics content. In this discussion, aromatics content is determined according to ASTM D5186. Based on the detection limits of ASTM D5186, any aromatics content less than 1.5 wt % corresponds to a sample that is substantially free of aromatics.

In some aspects, 50 wt % or more of a waxy feedstock can correspond to compounds formed by Fischer-Tropsch synthesis, or 60 wt % or more, or 75 wt % or more, or 90 wt % or more, such as up to substantially all of the waxy feedstock corresponding to Fischer-Tropsch synthesis products. In other aspects, 50 wt % or more of a waxy feedstock can correspond to a mineral feed or fraction, or 60 wt % or more, or 75 wt % or more, such as up to 95 wt % or possibly still higher. In such aspects, if Fischer-Tropsch products are included in the waxy feedstock, the Fischer-Tropsch material can correspond to 5.0 wt % to 50 wt % of the waxy feedstock, or 5.0 wt % to 40 wt %, or 5.0 wt % to 25 wt %, or 15 wt % to 50 wt %, or 15 wt % to 40 wt %, or 15 wt % to 25 wt %. Optionally, a portion of the waxy feedstock can correspond to bio-derived components. Optionally, a portion of the waxy feedstock can correspond to bio-derived components that are not formed by a Fischer-Tropsch synthesis process. Optionally, depending on the aspect, bio-derived components (optionally not formed by Fischer-Tropsch synthesis) can correspond to 1.0 wt % to 50 wt % of a waxy feedstock, or 1.0 wt % to 20 wt %, or 1.0 wt % to 10 wt %, or 10 wt % to 50 wt %.

### Hydrocracking Conditions and Hydrocracking Products

In various aspects, a waxy feedstock can be exposed to a hydrocracking catalyst under hydrocracking conditions to produce a hydrocracked effluent. The hydrocracking catalyst can correspond to a noble metal catalyst supported on a low acidity support that includes both a 3-dimensional zeotype framework structure and a low acidity binder.

The 3-dimensional zeotypes can include, for example, FAU framework structure (such as USY), *BEA framework structure (such as zeolite Beta), and MSE framework structure (such as MCM-68). In some aspects, the 3-dimensional zeotype can correspond to a zeotype with a 12-member ring as the ring size for the largest pore channel. In some aspects, zeotype framework structures can correspond to 35 wt % or more of the support, or 50 wt % or more, or 60 wt % or more, such as up to 95 wt % or possibly still higher. In aspects where the zeotype corresponds to FAU framework structure (such as USY), the silicon to aluminum ratio of the FAU framework structure, prior to formulation with a binder, can be 25 or more, or 30 or more, such as up to 100 or possibly still higher. In aspects where the zeotype corresponds to *BEA framework structure (such as zeolite Beta), the silicon to aluminum ratio of the *BEA framework structure, prior to formulation with a binder, can be 10 or more, or 15 or more, such as up to 50 or possibly still higher. In aspects where the zeotype corresponds to MSE framework structure (such as MCM-68), the silicon to aluminum ratio of the MSE framework structure, prior to formulation with a binder, can be 10 or more, or 15 or more, such as up to 50 or possibly still higher.

In some aspects, the substantially non-acidic or low acidic oxide binder can correspond to a support based on silica, alumina, zirconia and/or titania. In some aspects, when the binder includes alumina, the binder can include non-fluorinated alumina (i.e., alumina that has not been exposed to a fluoridation treatment to increase acidity). In some aspects, a binder that includes 1.0 wt % or more of alumina can include substantially no silica (0.1 wt % or less.) In some aspects, the support (zeotype plus binder) can have an Alpha value of 15 or less prior to addition of the noble metal catalyst, or 10 or less, such as down to 1.0 or possibly still lower. The acidity of the support can be measured, for example, by determining an Alpha value for the support material prior to addition of the Group 8-10 noble metal. In various aspects, a catalyst can be used that includes a support material with an Alpha value of 15 or less, or 10 or less, or 7.5 or less, such as down to 1.0 or possibly still lower.

In various aspects, the amount of Group 8-10 noble metal on the support can correspond to 0.1 wt % to 3.0 wt %, relative to the total weight of the catalyst (metal plus support), or 0.1 wt % to 2.0 wt %, or 0.1 wt % to 1.0 wt %, or 0.3 wt % to 3.0 wt %, or 0.3 wt % to 2.0 wt %, or 0.3 wt % to 1.0 wt %. In some aspects, the Group 8-10 noble metal can be Pt, Pd, or a combination thereof. To form a catalyst, the noble metal can be added to the support by any convenient method, such as by incipient wetness.

Prior to hydrocracking, the waxy feedstock can optionally be exposed to a hydrotreatment catalyst under hydrotreating conditions. This can allow for removal of at least a portion of oxygen, sulfur, and/or nitrogen that may be present in the waxy feedstock. Such hydrotreatment can potentially also saturate olefins and/or aromatics present in the waxy feedstock.

In some aspects, the hydrocracking conditions can include a temperature 500° F. (260° C.) to 840° F. (449° C.), or 572° F. (300° C.) to 779° F. (415° C.), a hydrogen partial pressure of 500 psig to about 3000 psig (3.45 MPag to 20.7 MPag), liquid hourly space velocities of from 0.05 h⁻¹ to 10 h⁻¹, and hydrogen treat gas rates of from 35.6 m³/m³ to 1781 m³/m³ (200 SCF/B to 10,000 SCF/B). It is noted that hydrocracking can potentially be performed at temperatures greater than 415° C. However, as the temperature increases, thermal cracking of a feed can also occur. Additionally, “overcracking” of the feed can increasingly occur at higher temperatures, so that increasing amounts of the hydrocracking products correspond to naphtha (or lower) boiling range products, as opposed to distillate boiling range conversion products. Depending on the aspect, the reaction conditions can be selected to produce 30 wt % or more conversion of the waxy feedstock relative to 371° C., or 50 wt % or more, or 70 wt % or more, such as up to substantially complete conversion of the 371° C.+ portions of the waxy feedstock to compounds boiling below 371° C.

Exposing the waxy feedstock to the hydrocracking catalyst under hydrocracking conditions results in formation of a hydrocracked effluent. The hydrocracked effluent will typically include a gas portion (at 20° C. and 100 kPa-a) and a liquid portion. The liquid portion of the hydrocracked effluent can include a naphtha boiling range fraction, a distillate boiling range fraction, and optionally an unconverted portion corresponding to components that still have a boiling point of 371° C. or higher. In some aspects, recycle of unconverted bottom with a boiling point of 371° C. or higher can be used to provide for full conversion of the feedstock over multiple passes, even though the single-pass conversion for the feed is less than 100 wt %.

### Example 1—Preparation of Catalysts

Four catalysts that included 3-dimensional zeotypes in the support were prepared. The first catalyst corresponded to an 80:20 formulation of USY: Versal-300 binder (i.e., 80 wt % USY, 20 wt % alumina binder). The second catalyst corresponded to a 20:80 formulation of USY: Versal-300 binder. The third catalyst corresponded to a 35:65 formulation of MCM-68: Versal-300 binder. The fourth catalyst was a 65:35 formulation of zeolite Beta: Versal-300 binder. Each of these catalysts was impregnated with a tetra-amine platinum nitrate solution, targeting 0.6% Pt by weight.

To make the supports containing a zeotype framework structure bound with alumina extrudate: Zeolite crystals and VERSAL-300™ alumina (available from Honeywell UOP) were mixed in a desired weight ratio. Sufficient water was added to produce an extrudable paste. The extrudable past was then used to form 1/16″ (0.16 cm) cylindrical extrudates. The prepared extrudates were dried at 250° F. (120° C.) for use. The dry extrudates were then pre-calcined at 1000° F. (540° C.) in nitrogen for 3 hours. The pre-calcined extrudates were exchanged two times with 1 N NH₄NO₃ solution. The H-form extrudates were dried at 250° F. (120° C.) for use. The dry extrudates were then calcined at 1000° F. (540° C.) in air for 6 hours.

After forming the extrudates, a Group 8-10 noble metal (Pt) was impregnated on the extrudates. The calcined extrudates from Materials were impregnated via incipient wetness with tetraamine complexes of platinum metal. A mixture of sufficient water to fill the entire pore volume of the material as well as platinum tetraamine nitrate were added to the extrudate with enough concentration to achieve a metals concentration of roughly 0.6 wt % Pt. The extrudates were then dried at ambient temperature, followed by further drying for 4 hours at 250° F. (120° C.). After drying, the extrudate was calcined at 680° F. (360° C.) for 3 hours in air to produce finely dispersed metal oxides on the catalyst surface.

Characterization data for each support and/or corresponding catalyst is shown in Table 1 below.

TABLE 1
Physical Properties of Catalysts

| | | | Catalyst 3 | |
|---|---|---|---|---|
| | Catalyst 1 | Catalyst 2 | 35:65 | Catalyst 4 |
| | 80:20 | 20:80 | MCM- | 65:35 |
| | USY:Versal- | USY:Versal- | 68:Versal- | Beta:Versal- |
| | 300 | 300 | 300 | 300 |
| Metal Content | 0.61 wt | 0.56 wt | 0.53 wt | 0.55 wt |
| | % Pt | % Pt | % Pt | % Pt |
| Si/Al ratio of | 34.5 | 34.5 | 11 | 17.5 |
| zeotype | | | | |
| Si/Al ratio of | 3.57 | 0.169 | 0.403 | — |
| support | | | | |
| Pt dispersion | 1.33/0.87 | 1.32/0.84 | 1.03/0.58 | 1.20 |
| (H/Pt 250° C., | | | | |
| Total/Strong) | | | | |
| Catalyst loading | 0.43 | 0.48 | 0.53 | 0.45 |
| density (g/cc) | | | | |
| Metals alpha | 17 | — | — | 23 |
| Alpha (pre-Pt | 9.5 | 5.8 | 4.9 | — |
| impregnation) | | | | |
| Temperature | 0.221 | 0.448 | 0.122 | — |
| Programmed | | | | |
| Ammonia | | | | |
| Adsorption | | | | |
| (meq/g, pre-Pt | | | | |
| impreg) | | | | |
| Temperature | 0.211 | 0.431 | 0.115 | — |
| Programmed | | | | |
| Ammonia | | | | |
| Desorption | | | | |
| (meq/g, pre-Pt | | | | |
| impreg) | | | | |
| Collidine | 85.3 | 24.9 | 65.2 | — |
| adsorption | | | | |
| (micromoles/g, | | | | |
| pre-Pt | | | | |
| impregnation) | | | | |
| BET surface | 646 | 396 | 285 | 420 |
| area (m²/g, | | | | |
| pre-Pt | | | | |
| impregnation) | | | | |
| Micropore | 452 | 97 | 119 | 209 |
| surface area | | | | |
| (m²/g, | | | | |
| pre-Pt | | | | |
| impregnation) | | | | |
| Pore volume | 0.56 | 0.73 | 0.59 | 0.88 |
| (cc/g, pre-Pt | | | | |
| impregnation) | | | | |

As shown in Table 1, each of the catalysts had a Pt loading of roughly 0.6 wt %. Prior to adding the Pt, each support had an Alpha value less than 10. The catalyst loading density was between 0.40 and 0.55 g/cm³. The BET surface area for the supports varied somewhat more, with a range between 285 m²/g and 646 m²/g. Based on the micropore surface area values, a substantial portion of the surface area for each support corresponded to surface area outside of the micropores of the support. The pore volume for the supports ranged from 0.55 cm³/g to 0.90 cm³/g. The ammonia adsorption/desorption and the collidine adsorption are measures of acidity. For Pt dispersion, the measurable values are total adsorbed H₂ and weakly adsorbed H₂.

For comparison, additional catalysts were prepared. Table 2 lists the additional comparative catalysts. For catalysts with an alumina binder, the binder corresponded to Versal™ 300.

TABLE 2
Comparative Catalysts

| | |
|---|---|
| Catalyst A | 0.6 w % Pt on 80:20 ZSM-57:alumina |
| Catalyst B | 0.6 wt % Pt on 65:35 ZSM-23:alumina |
| Catalyst C | 0.9 wt % Pd/0.3 wt % Pt on 65:35 |
| | MCM-41:alumina |
| Catalyst D | 0.6 wt % Pt on Siral 30 silica-alumina |
| Catalyst E | 0.6 wt % Pt on silica-alumina |

### Example 2—Hydrocracking of Fischer-Tropsch Wax

The catalysts from Example 1 were tested for their ability to hydrocrack a Fischer-Tropsch wax feed. The targeted product is distillate-range molecules, so all yields and conversion are focused on this range of molecules. In this example, the wax fraction of the feed and products is defined as having a boiling point above 371° C., and the distillate range molecules are considered to have a boiling point in the range of 160° C.-370° C. Furthermore, yields of a given fraction after conversion indicate the total amount of molecules in that boiling range present, including both pre-existing molecules that were not converted as well as those that were cracked from higher boiling fractions, in an effort to give the full picture of the yields relevant to further downstream processing. The Fischer-Tropsch feed used for generating the examples herein included roughly 25 wt % of components boiling in the range of 160° C. to 370° C. Thus, if exposed to conditions where no conversion of wax occurs, the expected distillate yield would be near 25 wt %.

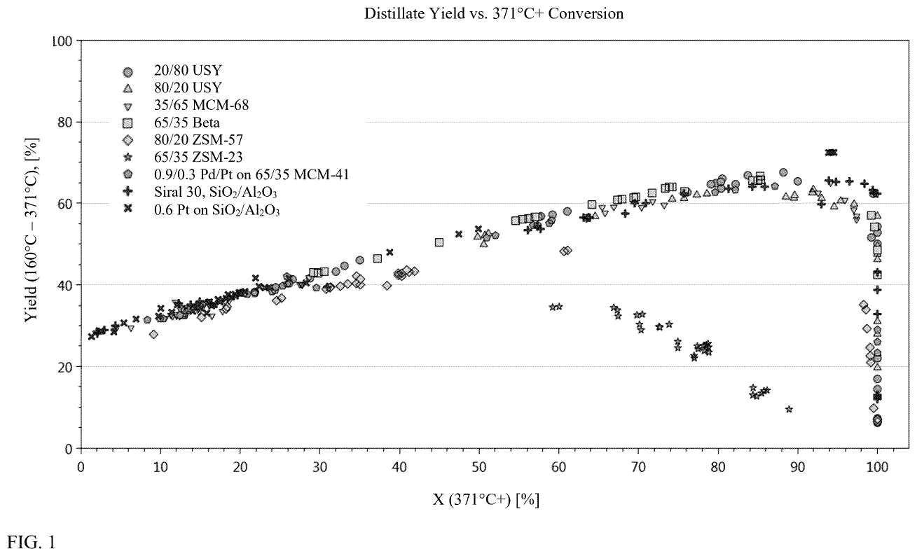

FIG. 1 shows the distillate yield versus amount of conversion for the catalysts shown in Table 1 (Catalysts 1-4) and the comparative catalysts shown in Table 2 (Catalysts A-E). As shown in FIG. 1, Catalysts 1-4 had similar profiles for the amount of distillate yield relative to the amount of conversion, with distillate yield steadily increasing until the conversion level reached roughly 90 wt % relative to 371° C. Beyond 90 wt % conversion, the distillate yield rapidly fell due to over-cracking of the products. This steady increase in yield up to 90 wt % conversion for Catalysts 1-4 is in contrast to the behavior for Catalyst A and Catalyst B, which plateau or decrease in distillate yield at around 60 wt % conversion. It is noted that both Catalyst A and Catalyst B correspond to 10-member ring zeolites and have either 1-dimensional or 2-dimensional pore networks.

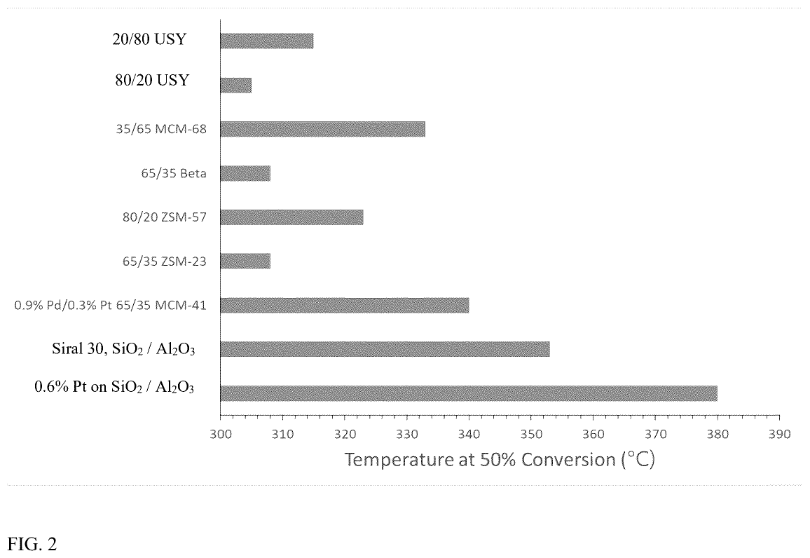

In FIG. 1, Catalysts C, D, and E have a similar conversion versus distillate yield profile in comparison with Catalysts 1-4. However, the reaction temperature required for Catalysts C, D, and E to achieve a target level of conversion is higher than the temperature for Catalysts 1-4. FIG. 2 shows the reaction temperature for achieving 50 wt % conversion of the Fischer-Tropsch wax feed. Catalysts 1-4 can achieve 50 wt % conversion of the feed (relative to 371° C.) at a temperature of 335° C. or less. By contrast, Catalysts C, D, and E require a temperature of 340° C. or more (or 350° C. or more) to achieve 50 wt % conversion. Thus, based on FIG. 1 and FIG. 2, Catalysts 1-4 provide comparable distillate yields to comparative Catalysts C, D, and E while achieving such yields at reduced operating temperatures.

The temperature for achieving 50 wt % conversion (relative to 371° C.) is important based on run length considerations. Over time, hydrocracking catalysts tend to deactivate, resulting in less conversion at a given temperature. In order to maintain conversion at a constant value during an extended run, the temperature for the hydrocracking process is increased over time. While this is effective, it is typically desirable to avoid increasing the temperature above roughly 400° C., in order to avoid the onset of substantial thermal cracking. Thus, the lower the temperature is for a fresh catalyst to achieve 50 wt % conversion, the lower the starting hydrocracking temperature will be for that catalyst for a given feed at a target level of conversion. This means that more temperature increase is available for performing an extended run length process prior to reaching 400° C.

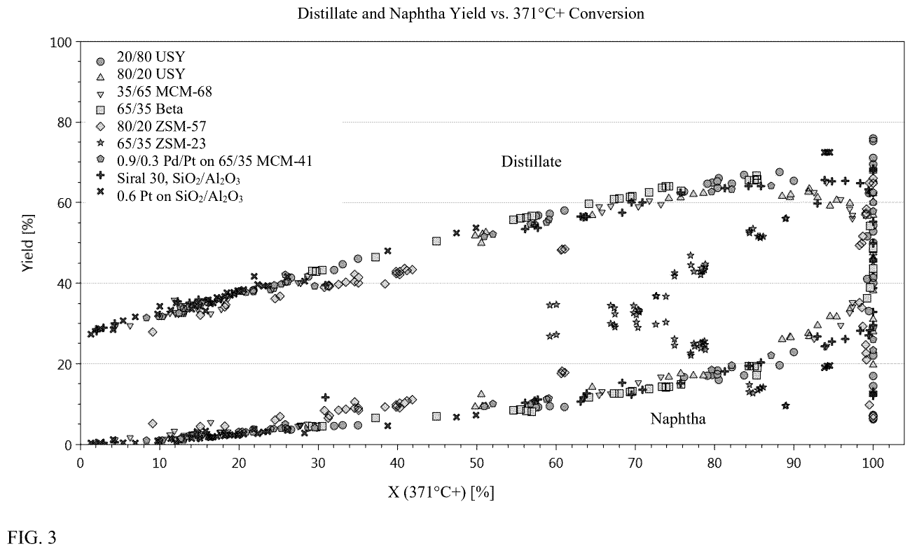

FIG. 3 shows a comparison of distillate yield and naphtha yield relative to the amount of conversion.

Table 3 shows characterization results for the distillate product generated using Catalyst 2 at two different levels of conversion.

TABLE 3
Distillate Characterization

| Catalyst | Catalyst 2 | Catalyst 2 |
|---|---|---|
| Nominal 700+° F. | 58.8% | 77.7% |
| Conversion, wt % | | |
| Cloud Point, ° C. | −6 | −11.3 |
| Total Aromatics, | 5.77 | 8.08 |
| mmol/kg | | |
| D2887 SimDist, ° F. | | |
| 1 wt % off | 300.6 | 285.9 |
| 5 wt % off | 353.3 | 349.8 |
| 20 wt % off | 442.7 | 426.6 |
| 50 wt % off | 549.6 | 527 |
| 80 wt % off | 637.2 | 617.5 |
| 95 wt % off | 692 | 683.4 |
| 99 wt % off | 716.5 | 712 |
| API Gravity | 50.0 | 50.6 |
| NMR Cetane | 78.7 | 76.13 |
| Number | | |

As shown in Table 3, the resulting distillate corresponded to a high cetane distillate fraction. This is not surprising, given the highly paraffinic nature of the Fischer-Tropsch wax feedstock. It is noted that cloud point appeared to improve with increasing conversion, while cetane number decreased.

### Additional Embodiments

Embodiment 1. A method for hydrocracking a waxy feedstock, comprising: exposing a feedstock comprising 70 wt % or more of paraffins and having a T10 distillation point of 300° C. or higher to a catalyst under hydrocracking conditions comprising 20 wt % or more conversion relative to 371° C. to form a hydrocracking effluent, the catalyst comprising 0.1 wt % to 3.0 wt % of a Group 8-10 noble metal on a support comprising a 3-dimensional 12-member ring zeotype framework and a metal oxide binder, the support having an Alpha value of 15 or less.
Embodiment 2. The method of Embodiment 1, wherein the 3-dimensional 12-member ring zeotype framework comprises USY, zeolite Beta, MCM-68, or a combination thereof.
Embodiment 3. The method of any of the above embodiments, wherein the support comprises 35 wt % or more of the 3-dimensional 12-member ring zeotype framework.
Embodiment 4. The method of the above embodiments, wherein the 3-dimensional 12-member ring zeotype framework comprises a) an FAU framework structure with a silicon to aluminum ratio of 25 or more; b) a *BEA framework structure with a silicon to aluminum ratio of 10 or more; c) an MSE framework structure with a silicon to aluminum ratio of 10 or more; d) a combination thereof.
Embodiment 5. The method of any of the above embodiments, wherein the metal oxide binder comprises silica, alumina, titania, zirconia, or a combination thereof.
Embodiment 6. The method of Embodiment 5, wherein the metal oxide binder comprises 1.0 wt % or more of alumina and is substantially free of silica, or wherein the alumina comprises non-fluorinated alumina, or a combination thereof.
Embodiment 7. The method of any of the above embodiments, wherein the feedstock comprises 70 wt % or more of n-paraffins, or 80 wt % or more of paraffins, or a combination thereof.
Embodiment 8. The method of any of the above embodiments, wherein the feedstock comprises 50 wt % or more of Fischer-Tropsch synthesis products.
Embodiment 9. The method of any of the above embodiments, wherein the feedstock comprises 1.0 wt % or more of bio-derived components, or wherein the feedstock comprises 1.0 wt % or more of oxygenates, or a combination thereof.
Embodiment 10. The method of any of the above embodiments, wherein the feedstock comprises a T10 distillation point of 315° C. or more, or wherein the feedstock comprises a T90 distillation point of 500° C. or more, or a combination thereof.
Embodiment 11. The method of any of the above embodiments, wherein the feedstock comprises a T10 distillation point of 343° C. or more, a T90 distillation point of 650° C. or less, or a combination thereof.
Embodiment 12. The method of any of the above embodiments, wherein the Group 8-10 noble metal comprises Pt, Pd, or a combination thereof.
Embodiment 13. The method of any of the above embodiments, the method further comprising hydrotreating a feed under hydrotreating conditions to form a hydrotreated effluent, the feedstock comprising a portion of the hydrotreated effluent.
Embodiment 14. The method of any of the above embodiments, wherein the feedstock comprises 2.5 wt % or less of aromatics.
Embodiment 15. The method of any of the above embodiments, wherein the hydrocracking conditions comprise a temperature of 335° C. or less.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

What is claimed is:

1. A method for hydrocracking a waxy feedstock, comprising:
exposing a feedstock comprising 70 wt % or more of paraffins and having a T10 distillation point of 280° C. or higher to a catalyst under hydrocracking conditions comprising 20 wt % or more conversion relative to 371° C. to form a hydrocracking effluent, the catalyst comprising 0.1 wt % to 3.0 wt % of a Group 8-10 noble metal on a support comprising a 3-dimensional 12-member ring zeotype framework and a metal oxide binder, the support having an Alpha value of 15 or less.

2. The method of claim 1, wherein the 3-dimensional 12-member ring zeotype framework comprises USY, zeolite Beta, MCM-68, or a combination thereof.

3. The method of claim 1, wherein the support comprises 35 wt % or more of the 3-dimensional 12-member ring zeotype framework.

4. The method of claim 1, wherein the 3-dimensional 12-member ring zeotype framework comprises an FAU framework structure with a silicon to aluminum ratio of 25 or more.

5. The method of claim 1, wherein the 3-dimensional 12-member ring zeotype framework comprises a *BEA framework structure with a silicon to aluminum ratio of 10 or more.

6. The method of claim 1, wherein the 3-dimensional 12-member ring zeotype framework comprises an MSE framework structure with a silicon to aluminum ratio of 10 or more.

7. The method of claim 1, wherein the metal oxide binder comprises silica, alumina, titania, zirconia, or a combination thereof.

8. The method of claim 7, wherein the metal oxide binder comprises 1.0 wt % or more of alumina and is substantially free of silica.

9. The method of claim 7, wherein the alumina comprises non-fluorinated alumina.

10. The method of claim 1, wherein the feedstock comprises 70 wt % or more of n-paraffins.

11. The method of claim 1, wherein the feedstock comprises 50 wt % or more of Fischer-Tropsch synthesis products.

12. The method of claim 1, wherein the feedstock comprises 1.0 wt % or more of bio-derived components.

13. The method of claim 1, wherein the feedstock comprises a T10 distillation point of 315° C. or more.

14. The method of claim 1, wherein the feedstock comprises a T10 distillation point of 343° C. or more, a T90 distillation point of 650° C. or less, or a combination thereof.

15. The method of claim 1, wherein the feedstock comprises a T90 distillation point of 500° C. or more.

16. The method of claim 1, wherein the Group 8-10 noble metal comprises Pt, Pd, or a combination thereof.

17. The method of claim 1, wherein the feedstock comprises 1.0 wt % or more of oxygenates.

18. The method of claim 1, the method further comprising hydrotreating a feed under hydrotreating conditions to form a hydrotreated effluent, the feedstock comprising a portion of the hydrotreated effluent.

19. The method of claim 1, wherein the feedstock comprises 80 wt % or more of paraffins.

20. The method of claim 1, wherein the feedstock comprises 2.5 wt % or less of aromatics.

21. The method of claim 1, wherein the hydrocracking conditions comprise a temperature of 335° C. or less.
